(19) United States
(12) Patent Application Publication
(10) Pub. No.: US 2017/0262279 A1
(43) Pub. Date: Sep. 14, 2017

(54) METHODS AND SYSTEMS FOR DEVELOPING USER CUSTOMIZABLE WEB APPLICATION FRAMEWORKS

(71) Applicant: Wipro Limited, Bangalore (IN)

(72) Inventors: Dattaguru Basavapatna Nanjundaiah, Bangalore (IN); Deepak Kumar Singh, Bangalore (IN); Madhu Sudhan Ramaiah, Bangalore (IN)

(73) Assignee: Wipro Limited

(21) Appl. No.: 15/082,460

(22) Filed: Mar. 28, 2016

(30) Foreign Application Priority Data
Mar. 12, 2016 (IN) 201641008687

(51) Int. Cl. G06F 9/44; H04L 29/08; H04L 29/06

(52) U.S. Cl. CPC G06F 8/77; H04L 63/083; H04L 65/403; H04L 67/141

(57) ABSTRACT

This disclosure relates generally to web application frameworks, particularly to, methods and systems for developing user customizable web application framework. In one embodiment, a method includes generating, by a network device, an application key based on a Unique Identifier (UID) associated with a project and a remote location of the user for a session; determining, by the network device, whether a user request received post user authentication is an Asynchronous JavaScript and XML (AJAX) POST request; comparing, by the network device, a token received with the user request with the application key for the session to determine a match, when the user request is an AJAX POST request; and continuing, by the network device, the session to serve requested data to the user when the token matches with the application key.

### TECHNICAL FIELD

This disclosure relates generally to web application frameworks and more particularly to methods and systems for developing user customizable web application frameworks.

### BACKGROUND

Development of User Experience Designs (UXD) is a complex software process, as it involves different types of stake holders and their subjective views. Moreover, the development of UXD may be context driven. Conventional frameworks are plagued by various challenges, which may include, but are not limited to security, learning curve, customization, adoptability, limitations, compatibility, light weight, and number of request. These challenges increase the time to market for developing UXD, especially when the development is for a specific context. Moreover, conventional frameworks fail to support end users' needs as well as reduction in development effort and learning phase.

### SUMMARY

In one embodiment, method for developing user customizable web application framework is disclosed. The method includes generating, by a network device, an application key based on a Unique Identifier (UID) associated with a project and a remote location of the user for a session; determining, by the network device, whether a user request received post user authentication is an Asynchronous JavaScript and XML (AJAX) POST request; comparing, by the network device, a token received with the user request with the application key for the session to determine a match, when the user request is an AJAX POST request; and continuing, by the network device, the session to serve requested data to the user when the token matches with the application key.

In another embodiment, a system for developing user customizable web application framework is disclosed. The system includes at least one processors and a computer-readable medium. The computer-readable medium stores instructions that, when executed by the at least one processor, cause the at least one processor to perform operations that include generating, by a network device, an application key based on a UID associated with a project and a remote location of the user for a session; determining, by the network device, whether a user request received post user authentication is AJAX POST request; comparing, by the network device, a token received with the user request with the application key for the session to determine a match, when the user request is an AJAX POST request; and continuing, by the network device, the session to serve requested data to the user when the token matches with the application key.

In yet another embodiment, a non-transitory computer-readable storage medium for developing user customizable web application framework is disclosed, which when executed by a computing device, cause the computing device to: generate an application key based on a UID associated with a project and a remote location of the user for a session; determine whether a user request received post user authentication is an AJAX POST request; compare a token received with the user request with the application key for the session to determine a match, when the user request is an AJAX POST request; and continue the session to serve requested data to the user when the token matches with the application key.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of an exemplary computer system for implementing various embodiments.

FIG. 2 is a block diagram illustrating a system for providing access to a user in a customizable web application framework, in accordance with an embodiment.

FIG. 3 illustrates a flowchart of a method for providing access to a user in a customizable web application framework, in accordance with an embodiment.

FIG. 4A illustrates a flowchart of a method for providing access to a user in a customizable web application framework, in accordance with another embodiment.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

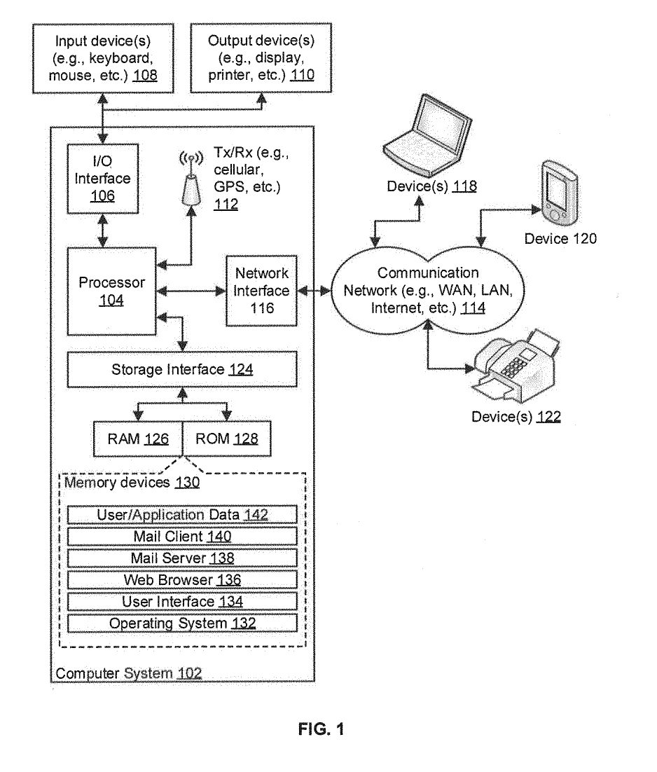

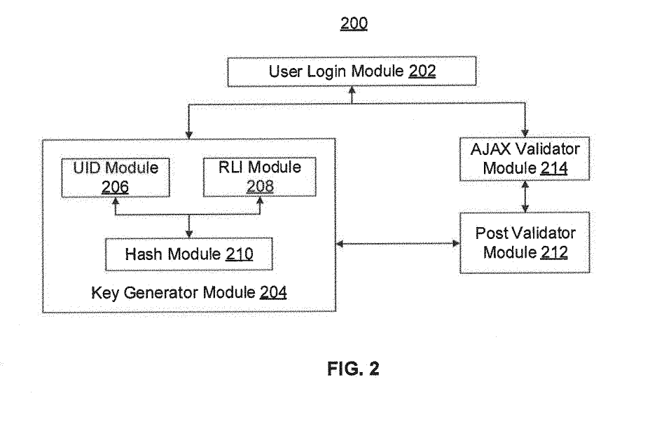

Additional illustrative embodiments are listed below. In one embodiment, a block diagram of an exemplary computer system for implementing various embodiments is disclosed in FIG. 1. Computer system 102 may comprise a central processing unit (“CPU” or “processor”) 104. Processor 104 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duran or Opteron, ARM's application, embedded or secure processors, IBM PowerPC, Intel's Core, Itanium, Xeon, Celeron or other line of processors, etc. Processor 104 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 104 may be disposed in communication with one or more input/output (I/O) devices via an I/O interface 106. I/O interface 106 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 106, computer system 102 may communicate with one or more I/O devices. For example, an input device 108 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 110 may be a printer, fax machine, video display (e.g., cathode ray tube (CRT), liquid crystal display (LCD), light-emitting diode (LED), plasma, or the like), audio speaker, etc. In some embodiments, a transceiver 112 may be disposed in connection with processor 104. Transceiver 112 may facilitate various types of wireless transmission or reception. For example, transceiver 112 may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, processor 104 may be disposed in communication with a communication network 114 via a network interface 116. Network interface 116 may communicate with communication network 114. Network interface 116 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. Communication network 114 may include, without limitation, a direct interconnection, local area network (LAN), wide area network (WAN), wireless network (e.g., using Wireless Application Protocol), the Internet, etc. Using network interface 116 and communication network 114, computer system 102 may communicate with devices 118, 120, and 122. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, computer system 102 may itself embody one or more of these devices.

In some embodiments, processor 104 may be disposed in communication with one or more memory devices (e.g., RAM 126. ROM 128, etc.) via a storage interface 124. Storage interface 124 may connect to memory devices 130 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory devices 130 may store a collection of program or database components, including, without limitation, an operating system 132, a user interface application 134, a web browser 136, a mail server 138, a mail client 140, a user/application data 142 (e.g., any data variables or data records discussed in this disclosure), etc. Operating system 132 may facilitate resource management and operation of the computer system 102. Examples of operating system 132 include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 134 may facilitate display, execution, interaction, manipulation, or operation of program components through textual or graphical facilities. For example, user interfaces may provide computer interaction interface elements on a display system operatively connected to computer system 102, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer system 102 may implement web browser 136 stored program component. Web browser 136 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, computer system 102 may implement mail server 138 stored program component. Mail server 138 may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, computer system 102 may implement mail client 140 stored program component. Mail client 140 may be a mail viewing application, such as Apple Mail, Microsoft Entourage, Microsoft Outlook, Mozilla Thunderbird, etc.

In some embodiments, computer system 102 may store user/application data 142, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

FIG. 2 is a block diagram illustrating a system 200 for providing access to a user in a customizable web application framework, in accordance with an embodiment. To access system 200, a user may open a web link and starts a session by keying in user login information through a user login module 202 on a login interface. The user login information includes a user Identifier (ID) and a password. The password may be encrypted using encryption techniques, which may include but are not limited to MD5, SHA1, and SHA256. User login module 202 validates the user ID and the password with the associated combination registered in a database in system 200. When the user has been validated and user login is successful, user login module 202 generates a session ID. The session ID is used for every transaction made by the user on system 200, till the user logs out by will or after expiration of a system defined time period.

After the user has logged in and before the user starts accessing other features of system 200, a key generator module 204 generates an application key using a Unique Identifier (UID) and a Remote Location Identifier (RLI) associated with user system. Key generator module 204 includes a UID module 206 that randomly generates a customizable UID for every project that the user initiates or works on. Additionally, key generator module 204 includes an RLI module 208 that queries the user system to fetch RLI of the user system. The RLI, for example, may be Internet Protocol (IP) address of the user system. Each of UID module 206 and RLI module 208 provide inputs to a hash module 210 in key generator module 204. Hash module 210 performs double hashing on UID and the IP address to generate the application key for a particular project. The hashing method used to generate the application key, may include, but is not limited to SHA512, MD5, SHA1, and SHA256. Each of user login module 202, UID module 206, RLI module 208, and hash module 210 are one time modules, such that, these modules are utilized only once till a particular session for a user us maintained.

An Asynchronous JavaScript and XML (AJAX) validator module 214 validates each subsequent request received from the user to access data. The validation is performed to determine whether the request is an AJAX POST request or not. In an embodiment, the validation may be performed by checking presence of a unique string “XMLHTTPREQUEST” in the request. If AJAX validator module 214 determines that the request is not an AJAX POST request, the ongoing session of the user is discontinued and the user is redirected to the login interface, such that, the user is again required to provide the login information.

After the AJAX validator module 214 determines that the request is an AJAX POST request, POST validator module 212 checks whether both the user ID and the session ID that was generated during the user login is available with a request received from the user. If even one of the user ID or the session ID are not available, POST validator module 212 discontinues the ongoing session of the user and redirects the user to the login interface, such that, the user is again required to provide the login information. This ensures that any unauthorized access to different pages within system 200 is controlled.

Further, POST validator module 212 performs various levels of check on the AJAX POST request. To this end, POST validator module 212 checks whether the AJAX POST request includes a valid token. The token may be an encrypted string of 32 characters and is generated using an algorithm. Thereafter, POST validator module 212 compares the token with the application key generated by key generator module 204. When the token received along with the AJAX POST request matches with the application key, POST validator module 212 grants the user access to data requested by the user. However, if the token does not match with the application key, POST validator module 212 logs the user out of the session and redirects the user to the login interface, such that, the user is again required to provide the login information.

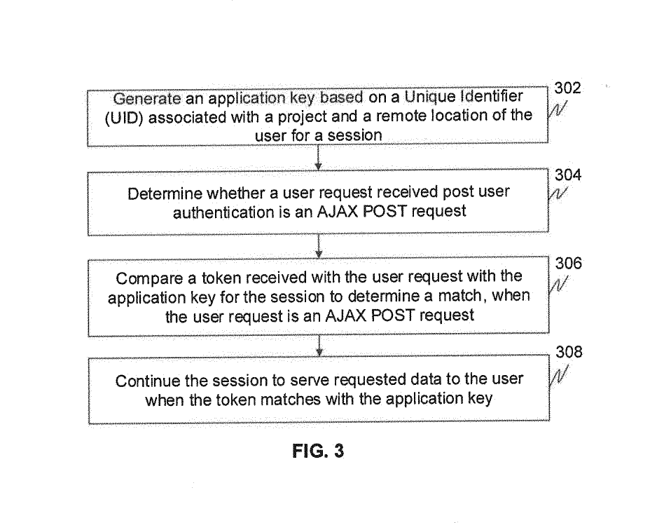

FIG. 3 illustrates a flowchart of a method for providing access to a user in a customizable web application framework, in accordance with an embodiment. To access the framework, a user opens a web link and provides user login information, which includes a user ID and a password. The password may be an MD5 encrypted password. When the user presses submit button on the web link to provide the login information, an AJAX POST request is sent to authenticate login information of the user. The login information of the user, i.e., the user ID and the password, is authenticated based on a combination of the user ID and the password registered in a database.

A session ID is generated after the user login information has been authenticated. The session ID is used for every transaction made by the user on system, till the user logs out by will or after expiration of a system defined time period. Thereafter, at 302, a network device generates an application key based on a UID associated with a project and a remote location of the user for a session. A UID is generated for every project that the user initiates or works on. The remote location may be represented using an RLI, for example, IP address of the user system. Double hashing is then performed on the UID and the IP address to generate the application key for a particular project. The hashing method used to generate the application key, may include, but is not limited to sha512.

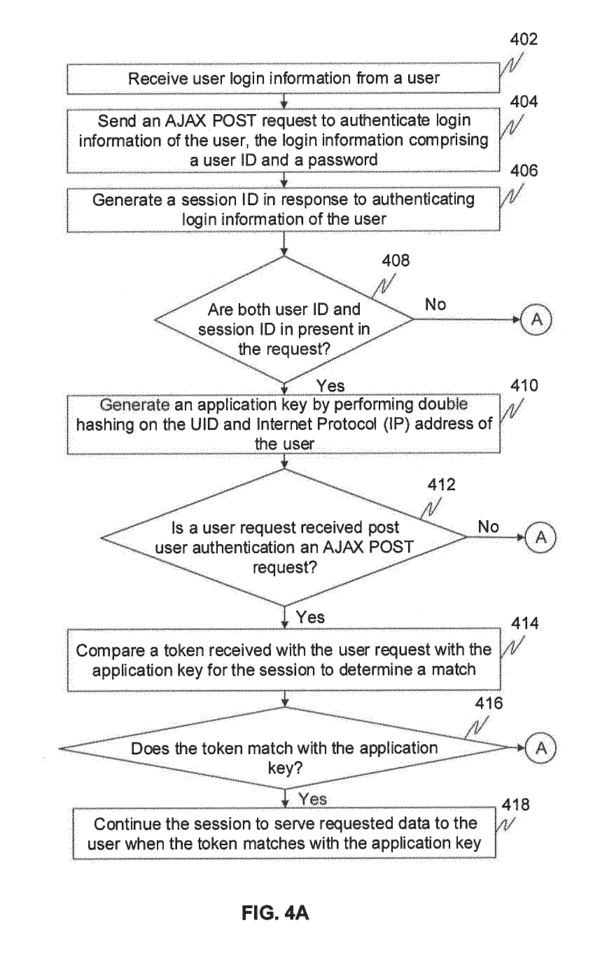

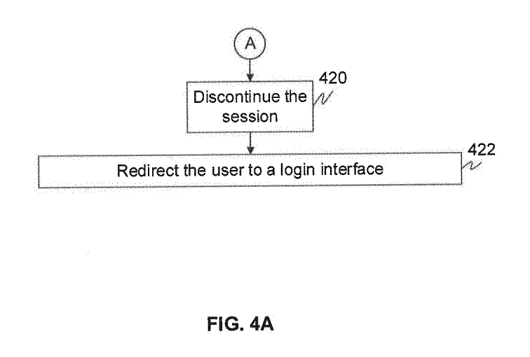

At 304, when the user is already logged in for a session, the network device determines whether a user request received post user authentication is an AJAX POST request or not. In an embodiment, the validation may be performed by checking presence of a unique string “XMLHTTPREQUEST” in the request. If the network device determines that the user request is not an AJAX POST request, current session of the user is discontinued and the user is redirected to the login interface, such that, the user is again required to provide the login information. This is further explained in detail in conjunction with FIG. 4A.

When the user request is an AJAX POST request, the network device, at 306, compares a token received with the user request with the application key generated for the session to determine a match. The token may be an encrypted string of 32 characters and is generated using an algorithm. When the token received along with the AJAX POST request matches with the application key, the network device, at 308, continues the session to serve requested data to the user. This is further explained in detail in conjunction with FIG. 4A.

Thus, a light weight web application framework is provided for secured access to ensure data security and data integrity. The framework has a modular structure, i.e., the framework has individual control for each application or functionality. Moreover, applications or functions can be disabled using basic configuration. The framework is also generalized and thus can be used for rapid and quick development of application prototypes. Additionally, as application is separated from data files in the framework, the load time is reduced. To ensure data security, request validations are performed, such that, data files can only be accessed by AJAX call with valid sessions and tokens. Finally, the framework is pull based as it start with the view layer, which can then “pull” results from multiple controllers using a single view.

FIG. 4A illustrates a flowchart of a method for providing access to a user in a customizable web application framework, in accordance with another embodiment. At 402, user login information that includes a user ID and a password is received from a user to access the framework. At 404, an AJAX POST request is sent to authenticate the login information of the user to the framework. The login information of the user, i.e., the user ID and the password, is authenticated based on a combination of the user ID and the password registered in a database. This has been explained in detail in conjunction with FIG. 3.

At 406, a session ID is generated in response to authenticating login information of the user. The session ID is used for every transaction made by the user on system, till the user logs out by will or after expiration of a system defined time period. Thereafter, at 408, a check is performed to determine if both the user ID and the session ID are included in a request received from the user. If either the user ID or the session ID is not included in the request received from the user, at 420, the ongoing session of the user is discontinued and thereafter, at 422, the user is redirected to a login interface, such that, the user is again required to provide the login information.

Referring back to 408, if both the user ID and the session ID are included in the request, an application key is generated at 410, by performing double hashing on the UID and IP address of the user. Thereafter, at 412, a check is performed to determine whether the request received from the user is an AJAX POST request. In an embodiment, the validation may be performed by checking presence of a unique string “XMLHTTPREQUEST” in the request. If the request is not an AJAX POST request, the control is passed to 420.

Referring back to 412, if the request in an AJAX POST request, a token received with the AJAX POST request is compared with the application key for the session, at 414, to determine a match. The token may be an encrypted string of 32 characters and is generated using an algorithm. Thereafter, a check is performed at 416 to determine whether the token matches with the application key. If the token does not match with the application key, the control is passed to 420. However, if the token matches with the application key, the ongoing session is continued and the user is served the requested data at 418.

Various embodiments of the invention provide methods and systems for developing user customizable web application framework. A light weight web application framework is disclosed that provides secured access to ensure data security and data integrity. The framework has a modular structure, i.e., the framework has individual control for each application or functionality. Moreover, applications or functions can be disabled using basic configuration. The framework is also generalized and thus can be used for rapid and quick development of application prototypes. Additionally, as application is separated from data files in the framework, the load time is reduced. To ensure data security, request validations are performed, such that, data files can only be accessed by AJAX call with valid sessions and tokens. Finally, the framework is pull based as it start with the view layer, which can then “pull” results from multiple controllers using a single view.

The specification has described methods and systems for developing user customizable web application framework. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of providing access to a user in a customizable web application framework, the method comprising:
generating, by a network device, an application key based on a Unique Identifier (UID) associated with a project and a remote location of the user for a session;
determining, by the network device, whether a user request received post user authentication is an Asynchronous JavaScript and XML (AJAX) POST request;
comparing, by the network device, a token received with the user request with the application key for the session to determine a match, when the user request is an AJAX POST request; and
continuing, by the network device, the session to serve requested data to the user when the token matches with the application key.

2. The method of claim 1 further comprising sending an AJAX POST request to authenticate login information of the user, the login information comprising a user ID and a password.

3. The method of claim 2 further comprising generating a session ID in response to authenticating login information of the user.

4. The method of claim 3 further comprising checking availability of the user ID and the session ID in the user request.

5. The method of claim 4 further comprising discontinuing the session when at least one of the user ID and the session ID is unavailable.

6. The method of claim 1, wherein generating the application key comprises performing double hashing on the UID and the remote location of the user, the remote location comprising Internet Protocol (IP) address of the user.

7. The method of claim 1 further comprising discontinuing the session when the user request is not an AJAX POST request.

8. The method of claim 1 further comprising discontinuing the session when the token does not match with the application key.

9. The method of claim 1 further comprising redirecting the user to a login webpage when the token does not match with the application key.

10. A system for providing access to a user in a customizable web application framework, the system comprising:
at least one processors; and
a computer-readable medium storing instructions that, when executed by the at least one processor, cause the at least one processor to perform operations comprising:
generating an application key based on a Unique Identifier (UID) associated with a project and a remote location of the user for a session;
determining whether a user request received post user authentication is an Asynchronous JavaScript and XML (AJAX) POST request;
comparing a token received with the user request with the application key for the session to determine a match, when the user request is an AJAX POST request; and
continuing the session to serve requested data to the user when the token matches with the application key.

11. The system of claim 10, wherein the operations further comprise sending an AJAX POST request to authenticate login information of the user, the login information comprising a user ID and a password.

12. The system of claim 11, wherein the operations further comprising generating a session ID in response to authenticating login information of the user.

13. The system of claim 12, wherein the operations further comprise checking availability of the user ID and the session ID in the user request.

14. The system of claim 13, wherein the operations further comprise discontinuing the session when at least one of the user ID and the session ID is unavailable.

15. The system of claim 10, wherein the operation of generating the application key comprises the operation of performing double hashing on the UID and the remote location of the user, the remote location comprising Internet Protocol (IP) address of the user.

16. The system of claim 10, wherein the operations further comprise discontinuing the session when the user request is not an AJAX POST request.

17. The system of claim 10, wherein the operations further comprise discontinuing the session when the token does not match with the application key.

18. The system of claim 10, wherein the operations further comprise redirecting the user to a login webpage when the token does not match with the application key.

19. A non-transitory computer-readable storage medium for providing access to a user in a customizable web application framework, when executed by a computing device, cause the computing device to:
generate an application key based on a Unique Identifier (UID) associated with a project and a remote location of the user for a session;
determine whether a user request received post user authentication is an Asynchronous JavaScript and XML (AJAX) POST request;
compare a token received with the user request with the application key for the session to determine a match, when the user request is an AJAX POST request; and
continue the session to serve requested data to the user when the token matches with the application key.

20. The non-transitory computer-readable storage medium of claim 19, wherein the operations further comprise:
sending an AJAX POST request to authenticate login information of the user, the login information comprising a user ID and a password; and
generating a session ID in response to authenticating login information of the user.
